(19) United States
(12) Patent Application Publication
(10) Pub. No.: US 2025/0206056 A1
(43) Pub. Date: Jun. 26, 2025

(54) PRODUCTION OF BOOKS WITH PRINTING OF IDENTIFICATION INFORMATION ON FASTENING LININGS

(71) Applicant: MECCANOTECNICA S.P.A., Gazzaniga (IT)

(72) Inventor: Alfredo CORDELLA, Bagnatica (IT)

(73) Assignee: MECCANOTECNICA S.P.A., Gazzaniga (IT)

(21) Appl. No.: 18/845,376

(22) PCT Filed: Mar. 13, 2023
(86) PCT No.: PCT/IT2023/050076

§ 371 Date: Sep. 9, 2024

(30) Foreign Application Priority Data
Mar. 15, 2022 (IT) 102022000005018

(51) Int. Cl. B42C 9/00; B41J 3/44; B42C 11/04; B42C 19/00; G06T 7/00

(52) U.S. Cl. CPC B42C 9/0056; B41J 3/445; B42C 11/04; G06T 7/001; B42C 19/00; G06T 2207/30144

(57) ABSTRACT

A solution is proposed for use in the production of books (166) in a bookbinding plant (100). A corresponding method (500) comprises reading (509) identification information (220) from each book block (112) and printing (521) further identification information (240,245) corresponding thereto onto a fastening lining (235) for application to the book block (112). A further aspect provides a corresponding system (103). Further aspects provide a back-gluing machine (103) and a bookbinding plant (100) comprising such system (103). A further aspect provides a computer program for implementing the method and a corresponding computer program product.

### DESCRIPTION

### Technical Field

The present invention relates to the bookbinding field. More specifically, this invention relates to the production of books with fastening linings.

### Technology Background

The background of the present invention is introduced hereinafter with the discussion of techniques relating to its context. However, even when this discussion refers to documents, acts, artifacts and the like, it does not suggest or represent that the discussed techniques are part of the prior art or are common general knowledge in the field relevant to the present invention.

The production of books involves a sequence of different processing steps, which are performed on corresponding book blocks in processing stations of a bookbinding plant in industrial applications. For example, in case of books of hard-cover type this comprises an application of endpapers to the sides of the book blocks, an application of fastening linings around spines of the book blocks, a trimming of free sides of the book blocks and an application of corresponding (hard) covers.

For this purpose, it is needed to be capable of identifying the book blocks. Particularly, this is required to establish corresponding configurations of the processing stations (such as for controlling sizes of the endpapers, lengths of the fastening linings and trimming formats of the book block), for moving the book blocks in the processing stations and between them when implemented in separate bookbinding machines (such as a back-gluing machine, a three-knife trimming machine and a case-in machine), for verifying the correctness of the processing steps (such as a correspondence between book blocks and covers) and so on.

The manual identification of book blocks through inspection thereof by operators of the bookbinding plant is inefficient and prone to human error. Particularly, this becomes very difficult (if not impossible) in case of production of books in small batches. In fact, the advent of digital printing has led to the production being more and more frequent of production batches each formed by a few copies, down to the production of single books on demand. In this case, the characteristics of the books to be produced vary continually among different production batches, so that their manual management would place an unsustainable burden on the operators.

As a result, it is common practice to print barcodes identifying them on a first page of the book blocks (for example, in scrap areas intended to be removed during the trimming of the book blocks). The barcodes are read by a corresponding reader. A content of the barcodes is used to retrieve information relating to the book blocks (for example, from corresponding configuration files). This information may be used to configure the bookbinding plant and to verify the correctness of the processing of the book blocks.

However, in the case of application of the endpapers to the book blocks (such as in the production of books with hard-covers) they cover the barcodes. As a consequence, the book blocks with the endpapers applied thereto become unrecognizable in the next processing steps; particularly, book blocks being different but with the same sizes are visually identical for the operators.

A recurring technique for allowing identifying the book blocks with the endpapers involves coupling them with worksheets on which the barcodes are printed; for example, the worksheets of each production batch are inserted into a tray used to move the corresponding book blocks. However, this requires a series of manual operations (being inefficient and error prone). Moreover, the worksheets may be coupled in wrong way with the book blocks or they may be lost relatively easily.

Alternatively, it is possible to apply adhesive labels (on which the barcodes are printed) to the endpapers manually. However, in this case as well the labels may be coupled in wrong way with the book blocks. Moreover, the labels may remain visible in relief in the corresponding books, thereby adversely affecting their quality.

Any mistake in the identification of the book blocks involves their discarding with waste of corresponding material and processing time, with the additional burden of repeating all the processing steps of the discarded book blocks.

A different technique involves printing the barcodes onto an exposed page of the endpapers. However, the barcodes might be visible in transparency in the corresponding books (for example, in case of printing with particularly dark inks and/or of particularly thin endpapers), thereby adversely affecting their quality.

Several examples of use of identification information for the production of books are described in EP-A-2269823, US-A-2008/138170, US-A-2009/279986, EP-A-1693226, EP-A-2789473, WO-A-2007/111826 and US-A-2006/210379.

### SUMMARY

A simplified summary of the present invention is herein presented in order to provide a basic understanding thereof; however, the sole purpose of this summary is to introduce some concepts of the invention in a simplified form as a prelude to its following more detailed description, and it is not to be interpreted as an identification of its key elements nor as a delineation of its scope.

In general terms, the present invention is based on the idea of printing identification information on fastening linings of the book blocks.

Particularly, an aspect provides a method for use in the production of books in a bookbinding plant. The method comprises reading identification information from each book block and printing further identification information corresponding thereto onto a fastening lining for application to the book block.

A further aspect provides a corresponding system.

A further aspect provides a back-gluing machine comprising such system.

A further aspect provides a bookbinding plant comprising such system.

A further aspect provides a computer program for implementing the method.

A further aspect provides a corresponding computer program product.

More specifically, one or more aspects of the present invention are set out in the independent claims and advantageous features thereof are set forth in the dependent claims, with the wording of all the claims that is incorporated herein verbatim by reference (with any advantageous feature provided with reference to each specific aspect that applies mutatis mutandis to every other aspect).

### BRIEF DESCRIPTION OF THE DRAWINGS

The solution of the present invention, as well as further features and the respective advantages, will be better understood with reference to the following detailed description, provided purely by way of a non-restrictive indication, to be read in conjunction with the accompanying drawings (wherein, for the sake of simplicity, corresponding elements are denoted with equal or similar references and their explanation is not repeated, and the name of each entity is generally used to denote both its type and its attributes, like value, content and representation). In this respect, it is expressly intended that the drawings are not necessary drawn to scale (with some details that may be exaggerated and/or simplified) and that, unless otherwise indicated, they are merely used to illustrate the structures and procedures described herein conceptually. In addition, orientations and related position references (such as upper, lower, lateral and so on) are to be understood in relation to a condition of use of the corresponding entities. Particularly:

FIG. 1 shows a schematic representation of a bookbinding plant wherein the solution according to an embodiment of the present invention may be applied,

FIG. 2A-FIG. 2F show the general principles of the solution according to an embodiment of the present invention,

FIG. 3A-FIG. 3E show an example of implementation of the solution according to an embodiment of the present invention,

FIG. 4 shows the main software components that may be used to implement the solution according to an embodiment of the present invention, and

FIG. 5A-FIG. 5C show an activity diagram describing the flow of activities relating to an implementation of the solution according to an embodiment of the present invention.

### DETAILED DESCRIPTION

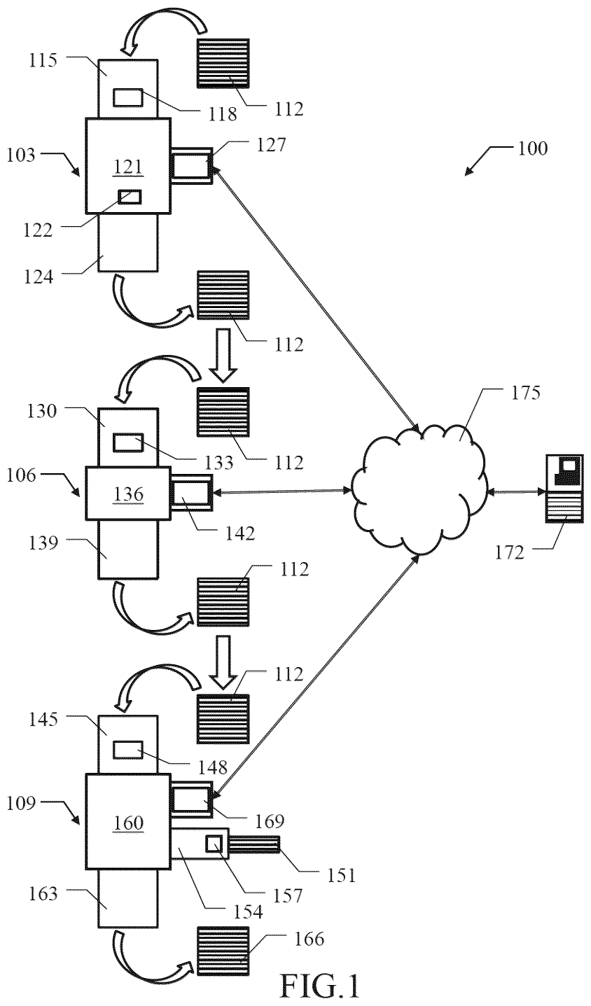

With reference in particular to FIG. 1, a schematic representation is shown of a bookbinding plant 100 wherein the solution according to an embodiment of the present invention may be applied.

The bookbinding plant 100 is used to produce books, or at least to perform one or more processing steps thereof, in corresponding processing stations. For example, the bookbinding plant 100 produces books of hard-cover type; the books are produced in (production) batches, each comprising a predetermined number of copies, all identical to each other, of a corresponding book. In general, the production batches are small, each formed by a few number of books, down to only one in the production of books on demand.

For this purpose, the bookbinding plant 100 comprises a series of bookbinding machines being separate to each other, comprising a back-gluing machine 103 that completes the book blocks with endpapers and fastening linings, a three-knife trimming machine 106 that trims the book blocks by removing scrap portions thereof and a case-in machine 109 that applies (hard) covers to the book blocks.

Book blocks 112 (to be completed) are supplied to the back-gluing machine 103 from preceding bookbinding machines, for example, transported manually by operators of the bookbinding plant 100 by means of pallets (not shown in the figure). For example, for each production batch, a digital printer prints corresponding pages of the books onto flat sheets and a combined (folding/sewing) machine folds the sheets into signatures and sews them into the book blocks. The back-gluing machine 103 has an infeed station 115 that receives the book blocks 112 in succession, each loaded horizontally onto an input belt thereof. A barcode reader 118 is arranged above the input belt (at a distance greater than a maximum thickness of the book block 112 so as not to interfere with its passage) for reading identification information being present thereon (as described in detail in following). The book block 112 is overturned vertically (with its spine downwards) and transported in succession through a series of processing stations 121 of the back-gluing machine 103. Particularly, in order the processing stations 121 comprise a spine-nipping station that presses the book block 112 at its spine, a glue-application station that applies a layer of glue onto a front and a back of the book block 112, an end-papering station that applies a pair of endpapers onto the front and the back of the book block 112, a (further) glue-application station that applies a layer of glue onto the spine and onto adjacent portions of the front and of the back of the book block 112, a lining-application station that applies a (fastening) lining embracing the spine of the book block 112 and a pressing station that presses the lining onto the book block 112. In the solution according to an embodiment of the present invention, as described in detail in the following, the back-gluing machine 103 also comprises a printing device 122 that prints (further) identification information corresponding to the identification information of the book block 112 onto its lining. A lay-down station 124 outputs the (completed) book blocks 112 in succession. A control system, or simply computer 127 (for example, based on an industrial PC) controls operation of the back-gluing machine 103.

The book blocks 112 being output by the back-gluing machine 103 are transported to the three-knife trimming machine 106, for example, manually by the operators by means of (further) pallets (not shown in the figure). The three-knife trimming machine 106 has an infeed station 130 that receives the book blocks 112 in succession, each loaded horizontally onto an input belt thereof. In the solution according to an embodiment of the present invention, as described in detail below, a barcode reader 133 is arranged above the input belt (at a distance greater than a maximum thickness of the book block 112 so as to not interfere with its passage) for reading the identification information being printed on the lining of the book block 112. The book block 112 is transported in succession through one or more cutting stations 136, which cut the book block 112 at a lip, a head and a foot for removing its scrap portion. A lay-down station 139 outputs the (trimmed) book blocks 112 in succession. A control system, or simply computer 142 (for example, based on an industrial PC) controls operation of the three-knife trimming machine 106.

The book blocks 112 being output by the three-knife trimming machine 106 are transported to the case-in machine 109, for example, manually by the operators by means of (further) pallets (not shown in the figure). The case-in machine 109 has a book-block infeed station 145 that receives the book blocks 112 in succession, each loaded horizontally onto an input belt thereof. In the solution according to an embodiment of the present invention, as described in detail below, a barcode reader 148 is arranged above the input belt (at a distance greater than a maximum thickness of the book block 112 so as to not interfere with its passage) for reading the identification information being printed on the lining of the book block 112. Moreover, covers 151 to be applied to the book blocks 112 (for example, supplied by a further digital printer) are also transported to the case-in machine 109, for example, manually by the operators by means of (further) pallets (not shown in the figure). The case-in machine 109 has a cover infeed station 154 that extracts each cover 151 in succession from a stack being loaded manually into a hopper thereof. In the solution according to an embodiment of the present invention, as described in detail below, a camera 157 is arranged along a transit of the cover 151 (at a distance such as not to interfere with its passage). The book block 112 is overturned vertically (with its spine upwards) and transported in succession through a series of processing stations 160 of the case-in machine 109. Particularly, the processing stations 160 comprise a squaring station that levels the spine of the book block 112 (in case of books with squared spine), a glue-application station that applies a strip of glue to portions of the front and of the back adjacent to the spine of the book block 112, an engagement station that loads each book block 112 onto a transport blade, a casing station that applies the corresponding cover 151 (received from the cover infeed station 154) to the book block 112 by gluing it onto the front/back thereof and a pressing station that presses the cover 151 onto the book block 112 A lay-down station 163 outputs corresponding books 166 so obtained. A control system, or simply computer 169 (for example, based on an industrial PC) controls operation of the case-in machine 109. The books 166 are then transported outside the bookbinding plant 100, for example, manually by the operators by means of (further) pallets (not shown in the figure).

A central processing system, or simply server 172 manages an operation of the entire bookbinding plant 100. The computer 127, the computer 142, the computer 169 and the server 172 communicate among them over a network 175 (for example, a LAN).

Each of the above-described computing machines (i.e., computers 127,142,169 and server 172) comprise several units (not shown in the figure) that are connected among them through a bus structure at one or more levels, with an architecture that is suitably scaled according to the type of the computing machine 127,142,169,172. Particularly, a microprocessor (or more) provides the logic capability of the computing machine 127,142,169,172; a non-volatile memory (ROM) stores basic code for a bootstrap of the computing machine 127,142,169,172 and a volatile memory is used as a working memory by the microprocessor. The computing machine 127,142,169,172 is provided with a mass-memory for storing programs and data (for example, solid state disks). Moreover, the computing machine 127,142,169,172 comprises a number of controllers for peripherals, or Input/Output (I/O) units; for example, the peripherals comprise a touch screen for each computer 127,142,169 or a keyboard and a mouse for the server 172, a network card and a USB port for reading/writing removable memory devices (such as a memory key).

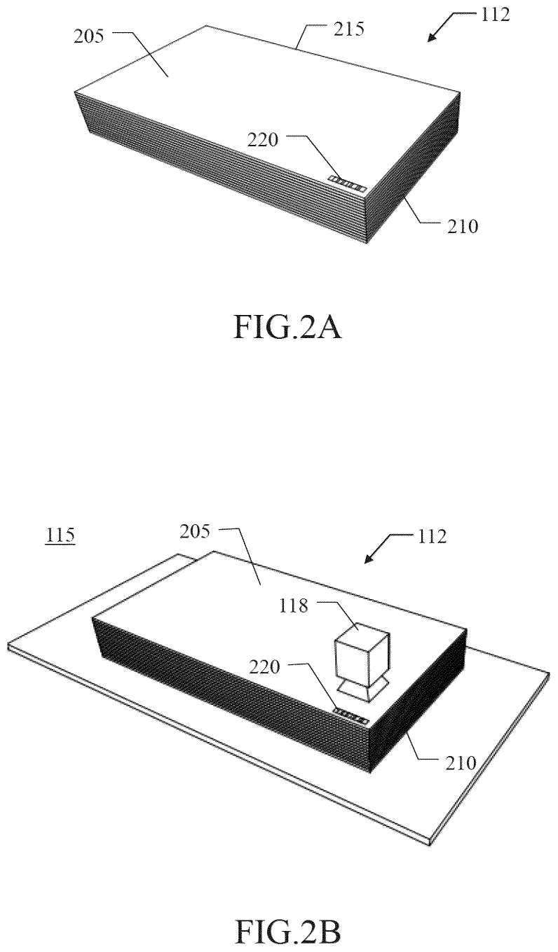

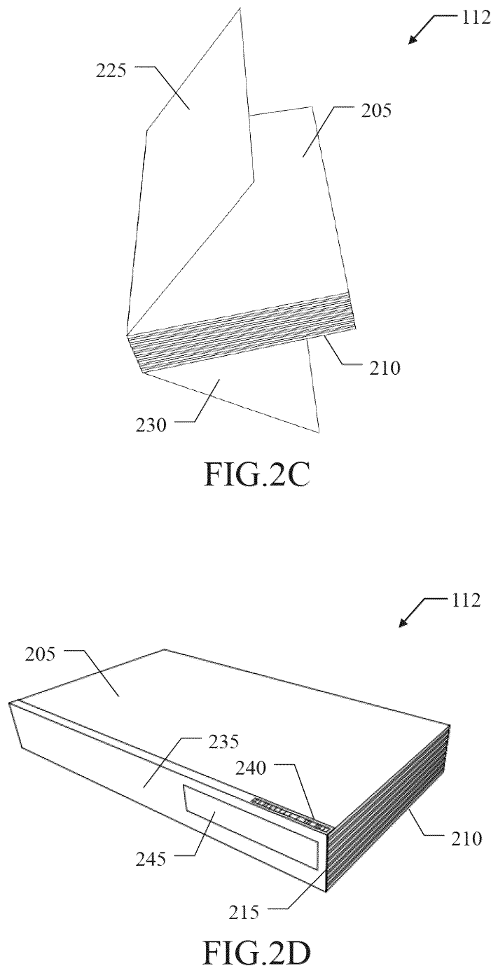

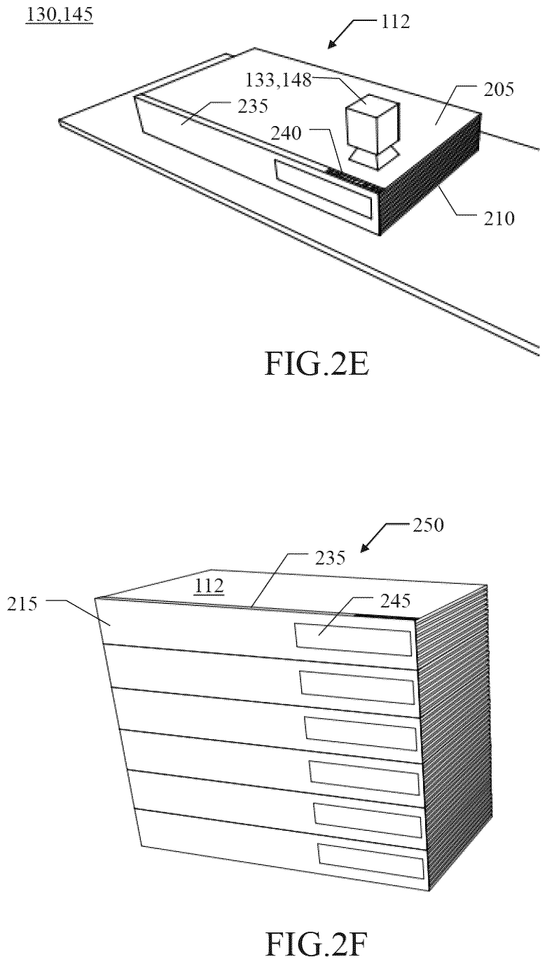

With reference now to FIG. 2A-FIG. 2F, the general principles are shown of the solution according to an embodiment of the present invention.

Starting from FIG. 2A, each book block 112 is formed by a block of signatures or sheets that are bound together (for example, stitched/glued). The book block 112 has a front 205 defined by a first page of the sheets/signatures, a back 210 defined by a last page of the sheets/signatures and a spine 215 between the front 205 and the back 210 at a binding of the sheets/signatures. Identification information of optical-readable type is visible outside the book block 112. For example, the identification information is defined by a book code that identifies the corresponding book. The book code is represented by a barcode 220, which is printed on the front 205. For example, the barcode 220 extends parallel to the spine 215 in the scrap portion of the book block 112 opposite thereto.

Moving to FIG. 2B, in the infeed station 115 of the back-gluing machine, the book block 112 is placed horizontally with the back 210 on its input belt, so that the front 205 with the bar code 220 faces upwards. As a consequence, when the book block 112 passes under the barcode reader 118 of the infeed station 115, it may read the barcode 220.

Moving to FIG. 2C, later on a (front) endpaper 225 and a (back) endpaper 230 are applied to the front 205 and to the back 210, respectively, of the book block 112. Each endpaper 225,230 is formed by a sheet (for example, white) that is folded in two parts, so as to define corresponding flaps each with the same sizes as the book block 112. A flap of the endpaper 225 is glued to the front 205 and a flap of the endpaper 230 is glued to the back 210 of the book block 112. The other flap of each endpaper 225,230 is intended to be subsequently glued in the case-in machine to corresponding plates of the cover (not shown in the figure), so as to improve its union with the book block 112. As a consequence, the flap of the endpaper 225 being glued on the front 205 completely covers the underlying barcode, which is therefore no longer visible outside the book block 112.

Moving to FIG. 2D, later on a (fastening) lining 235 is applied to embrace the spine 215 of the book block 112. The lining 235 has a length being equal to (or slightly greater than) a height of the book block 112 (along the spine 215). The lining 235 has a width being wider than the spine 215, with a central strip (for example, with a width of 2-100 mm) that is glued to the spine 215 and two lateral strips (for example, each with a width of 10-20 mm) that are glued to portions being adjacent to the spine 215 of the front 205 and of the back 210, respectively. The lining 235 exerts a fastening action on the sheets/signatures, thereby improving a compactness of the book block 112.

In the solution according to an embodiment of the present invention, (further) identification information of optical-readable type is printed onto the lining 235. This identification information corresponds to the barcode being read previously and now no longer visible (for example, extracted from a database). The identification information is thus again visible outside the book block 112 with the lining 235 applied thereto, so that it may be used in a next (automatic and/or manual) processing of the book block 112.

The above-mentioned solution makes the book blocks again identifiable (even when their identification information has been covered by the endpapers). This greatly improves the next processing of the book blocks. For example, the identification information on the linings of the book blocks may be used to configure next bookbinding machines (i.e., the three-knife trimmer machine and the case-in machine in this case), to move the book blocks between the bookbinding machines, to verify the correctness of the processing steps of the book blocks, to trace the production of the books and so on.

This solution reduces possible errors in the identification of the book blocks. This involves less wastes in the production of the books (and therefore less loss of corresponding material and processing time) and less additional costs for the repetition of the processing steps of the corresponding book blocks being discarded.

This result is obtained without affecting the quality of the books in any way. In fact, the identification information being printed on the lining is completely invisible once the covers have been applied to the book blocks.

The identification information that is printed onto the lining 235 may be either machine-readable or human-readable. For example, this identification information may comprise a further (job) code that identifies the corresponding production batch, which is represented by a (further) barcode 240 that is printed onto the lateral strip of the lining 235 being glued to the front 205 of the book block 112 (as shown in the figure) and/or onto the lateral strip of the lining 235 being glued to the back 210 of the book block 112 (not visible in the figure). In addition or in alternative, the identification information may comprise the (book) title of the corresponding book, which is represented by an alphanumeric text 245 that is printed onto the central strip of the lining 235 being glued to the spine 215 of the book block 112.

Moving to FIG. 2E, in the infeed station 130,145 of the three-knife trimming machine and of the case-in machine, the book block 112 is rested horizontally with the back 210 onto its input belt. In this case, the front 205 with the corresponding lateral strip of the lining 235 on which the barcode 240 has been printed faces upwards. As a consequence, when the book block 112 passes under the corresponding barcode reader 133,148 it may read the barcode 240. The printing of the identification information on (one or both) the lateral strips of the lining 235 is therefore particularly suitable for their machine reading.

Moving to FIG. 2F, the book blocks 112 being output by the back-gluing machine and by the three-knife trimming machine are generally arranged in stacks 250 (only one shown in the figure) for the transport by the operators to the three-knife trimming machine and to the case-in machine, respectively (not shown in the figure). In this case, the spine 215 of each book block 112 with the corresponding central strip of the lining 235 on which the alphanumeric text 245 has been printed faces outwards of the stack 250. As a consequence, the alphanumeric text 245 still remains visible to the operators who may read the book title of each book block 112. The printing of the identification information on the central strip of the lining 235 is therefore particularly suitable for their reading by persons.

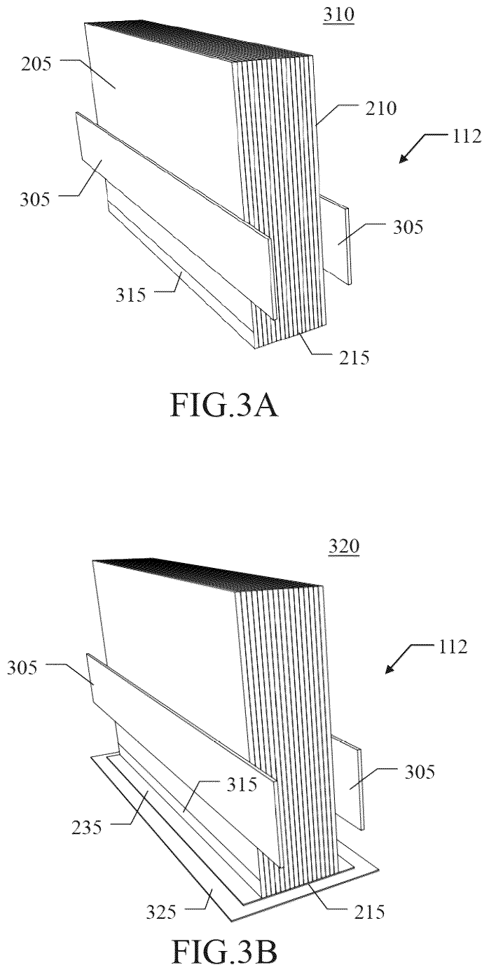

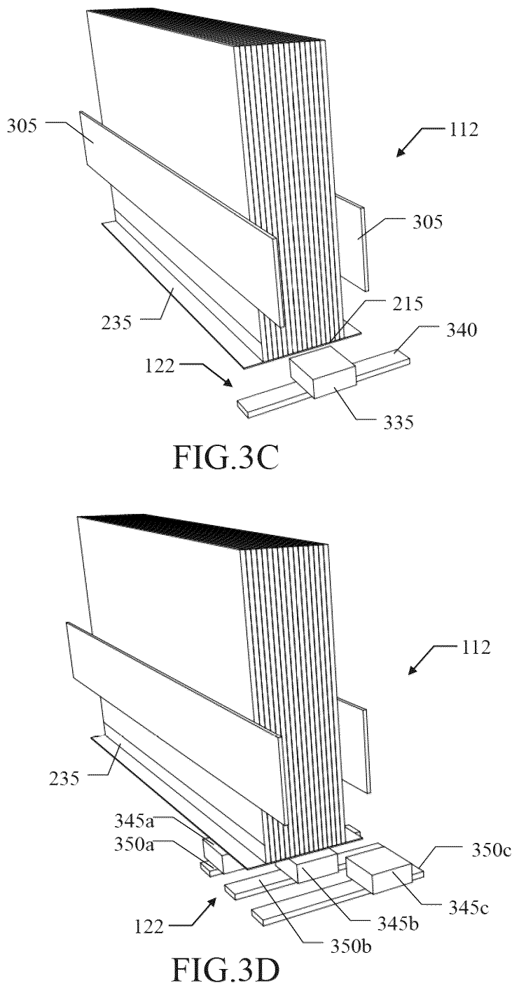

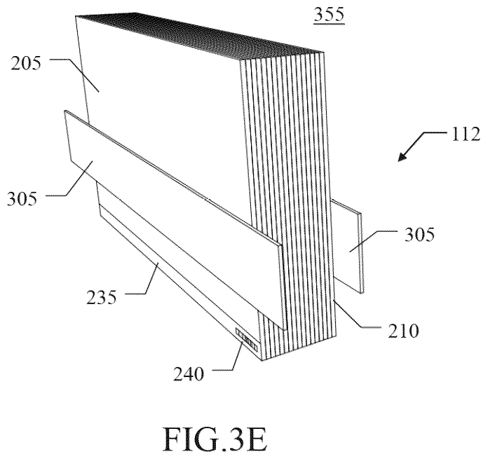

With reference now to FIG. 3A-FIG. 3E, an example is shown of implementation of the solution according to an embodiment of the present invention.

Starting from FIG. 3A, each book block 112 is transported vertically through the processing stations of the back-gluing machine (not shown in the figure) by means of a transport device, for example, a pair of belts 305, which grip it on the front 205 and on the back 210 at a certain distance from the spine 215 (facing downwards). While the book block 112 passes through the glue-application station for the lining, denoted with the reference 310, corresponding rollers or nozzles (not shown in the figure) apply a layer of glue 315 onto the spine 215 and onto portions being adjacent thereto of the front 205 and of the back 210 of the book block 112.

Moving to FIG. 3B, in the lining-application station, denoted with the reference 320, the lining 235 to be applied to the book block 112 is obtained from a roll of corresponding material (not shown in the figure). The roll has a width greater than a maximum height of the book block 112 (for example, 0.5 m). The material is unwound from the roll and at the same time cut to reduce its width to the length of the lining 235 (equal to or slightly greater than the height of the book block 112); the material is then cut for a length equal to the width of the lining 235. The lining 235 is carried (horizontally, transversally to a transport direction of the book block 112) onto a plate 325, in lowered position under the book block 112, so as to be arranged along this transport direction. The plate 325 is provided with suction holes (not visible in the figure); once the lining 235 has rested at the center of the plate 325, air is sucked out of the suction holes thereby keeping the lining 235 fixed in position. When the book block 112 reaches the lining-application station 320, the belts 305 are stopped with the book block 112 above the lining 235 (at the center thereof). The plate 325 is then raised until the lining 235 reaches the spine 215 of the book block 112. As shown in the figure, in this way the central strip of the lining 235 is glued to the spine 215 (by means of the corresponding strip of glue 315). The suction of air from the suction holes of the plate 325 is stopped and the plate 325 is lowered, thereby releasing the lining 235.

Moving to FIG. 3C, the belts 305 resume transporting the book block 112 from the lining-application station to the next pressing station (not shown in the figure). In this phase, the lining 235 is supported in its central strip by the spine 215 of the book block 112. The lateral strips of the lining 235 instead extend freely in a cantilever way at the sides of the book block 112. Nevertheless, thanks to the thickness of the lining 235 and to the width of the lateral strips, a downward deflection of the lateral strips of the lining 235 due to their weight is negligible in practice. Therefore, the entire lining 235 is substantially arranged horizontally.

In an embodiment of the present invention, during the transport from the lining-application station to the pressing station the lining 235 passes over the printing device 122. For example, in a specific implementation the printing device 122 comprises a printing head 335 of inkjet type (arranged under the book block 112). The printing head 335 is mounted on a guide 340, which is used to move the printing head 335 transversely to the book block 112. Before the book block 112 reaches the printing device 122, the guide 340 positions the printing head 335 at a selected (central/front/back) strip of the lining 235 (the central strip in the example shown in the figure). While the book block 112 passes over the printing head 335, it prints the identification information (barcode and/or alphanumeric text) onto the selected strip of the lining 235, by injecting the ink from the bottom upwards. This implementation is particularly simple.

Moving to FIG. 3D, in a different implementation the printing device 122 comprises three printing heads 345a, 345b and 345c of inkjet type (arranged under the book block 112). Again, the printing heads 345a, 345b and 345c are mounted on corresponding guides 350a, 350b and 350c, respectively, which are used to move the printing heads 345a-345c transversely to the book block 112 (independently among them). The printing heads 345a, 345b and 345c are used as above to print the identification information (barcode and/or alphanumeric text) onto the center strip, onto the front (lateral) strip, and onto the back (lateral) strip, respectively, of the lining 235. For this purpose, before the book block 112 reaches the printing device 122, the guides 350a-350c position the corresponding printing heads 345a-345c at the desired position of the corresponding strips of the lining 235. This implementation is particularly flexible, since it allows printing the identification information simultaneously onto multiple strips of the lining 235.

Moving to FIG. 3E, when the book block 112 reaches the pressing station, denoted with the reference 355, the belts 305 are stopped. Corresponding deflectors (not shown in the figure) fold the lateral strips of the lining 235 (with the barcode 240 visible in the figure) onto the corresponding portions of the front 205 and of the back 210 of the book block 112. Later on, the corresponding strips of the lining 235 are pressed against the front 205, against the back 210 and against the spine 215 to complete the gluing of the lining 235 onto the book block 112. Once the operation has been completed, the belts 305 resume transporting the book block 112 through the back-gluing machine.

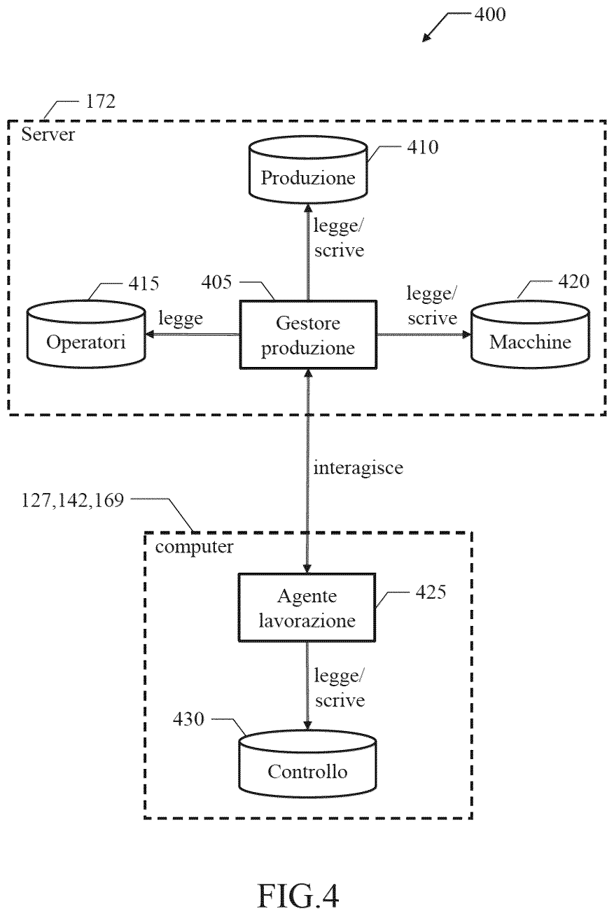

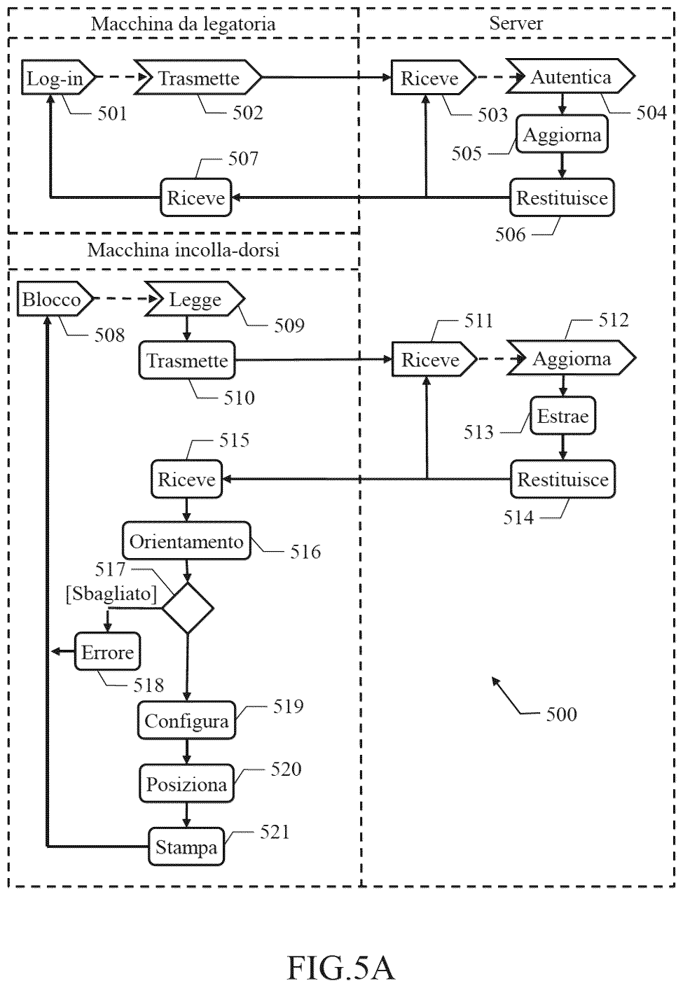

With reference now to FIG. 4, the main software components are shown that may be used to implement the solution according to an embodiment of the present invention.

Particularly, the software components (programs and data) are denoted as a whole with the reference 400. The software components 400 are typically stored in the mass memory and loaded (at least partially) into the working memory of each computing machine when the programs are running, in addition to an operating system and to possible other application programs not directly relevant to the solution of the present invention (thus omitted in the figure for the sake of simplicity). The programs are initially installed into the mass memory, for example, from removable storage units or from the network. In this respect, each program may represent a module, segment or portion of code, which comprises one or more executable instructions for implementing the specified logical function.

Particularly, the server 172 comprises the following components. A production manager 405 manages the production of the books in the bookbinding plant. The production manager 405 reads/writes a production repository 410, which contains production information relating to the production of the books. For example, the production repository 410 has an entry for each production batch. The entry stores information relating to the production batch (such as job code (jobID), number of copies and so on), to the corresponding books (such as title/author, printing orientation of the barcodes on the book blocks and so on), to the processing of the book blocks (such as format, loading orientation of the book blocks in each bookbinding machine and so on) and to the corresponding covers (for example, cover code, reference image of a front of the covers and so on). For example, each production batch has a descriptor file (such as in JDF format) having the job code as its name, which descriptor file comprises the information of above and/or a link thereto; particularly, the descriptor file contains the name of a file of a digital image that represents the reference image and directly all the other information. Moreover, the entry stores tracking information relating to a state of the production of the books of the production batch (such as books being produced and book blocks under processing, each with an indication of the bookbinding machines and the corresponding operators). The production manager 405 reads an operator repository 415 that contains information relating to the operators of the bookbinding plant. For example, the operator repository 415 has an entry for each operator. The entry stores an operator code (userID) and its secret password. The production manager 405 reads/writes a machine repository 420, which contains information relating to the bookbinding machines of the bookbinding plant (back-gluing machine, three-knife trimming machine and case-in machine). For example, the machine repository 420 has an entry for each bookbinding machine. The entry stores a machine code, the operator code of the operator who is working on it and so on. The production manager 405 interacts with corresponding processing agents 425 running on the computers 127,142,169 of the bookbinding machines. The processing agent 425 of each computer 127,142,169 reads/writes a control repository 430. The control repository 430 contains control information of the corresponding bookbinding machine for the book blocks under processing therein. Particularly, the control repository 430 stores the job code, the book title and the orientation of the bar codes; moreover, the control repository 430 stores configuration information of the bookbinding machine for the book blocks under processing therein, defined by the information relating to the processing of the book blocks (format, loading orientation of the book blocks) and by the information relating to the covers in the case of the case-in machine (cover code, reference image).

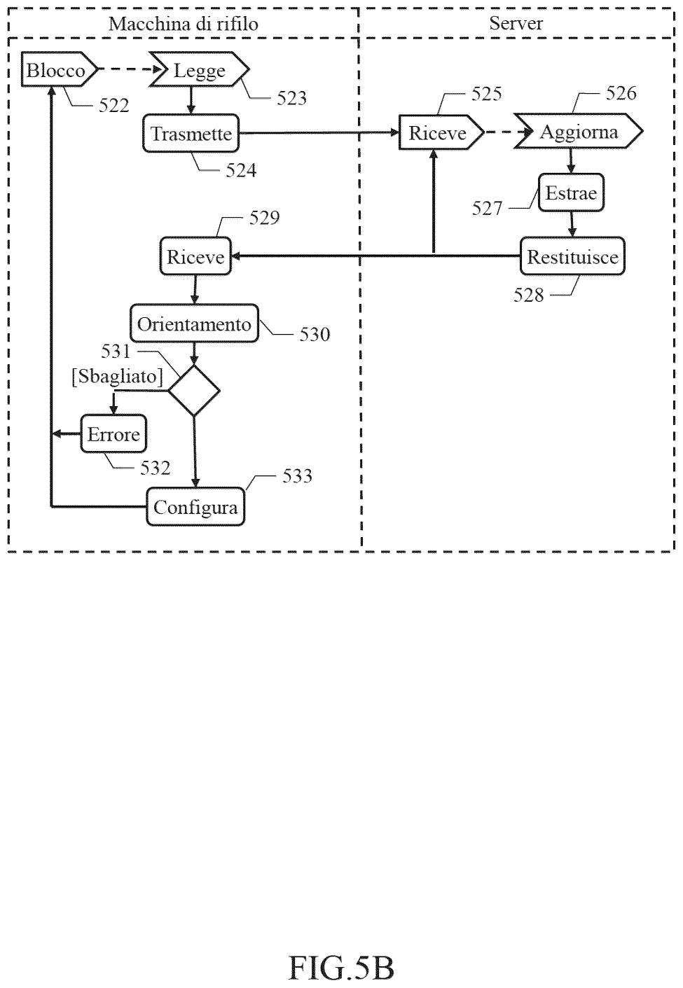

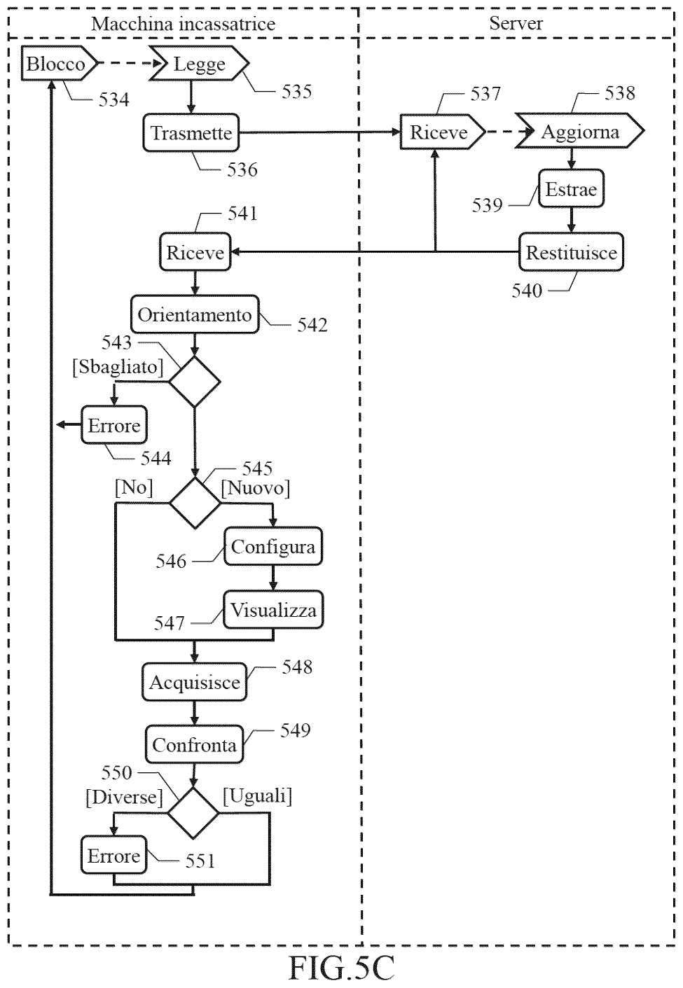

With reference now to FIGS. 5A-FIG. 5C, an activity diagram is shown describing the flow of activities relating to an implementation of the solution according to an embodiment of the present invention.

Particularly, the diagram represents an exemplary process that may be used to manage the production of books with a method 500. In this respect, each block may correspond to one or more executable instructions for implementing the specified logical function on the relevant computing machines.

Starting from the swim-lane of the computer of a generic bookbinding machine (back-gluing machine, three-knife trimming machine and case-in machine), the processing agent at block 501 receives access data (operator code and password) from an operator who starts working on the bookbinding machine, entered via the touch-screen of the computer. The processing agent at block 502 transmits a corresponding access request to the bookbinding machine (containing the machine code extracted from a corresponding register and the access data) to the server. Passing to the swim-lane of the server, the production manager at block 503 receives the access request (being in a listening condition for it). In response thereto, the production manager at block 504 authenticates the operator (according to the access data versus the operator repository). Assuming that the operator has been correctly authenticated, the production manager at block 505 updates the machine repository accordingly. The production manager at block 506 returns an access confirmation to the computer of the bookbinding machine. The process then returns to block 503 waiting for a next access request. With reference again to the swim-lane of the computer of the bookbinding machine, the processing agent at block 507 receives the access confirmation (being in a waiting condition for it from block 502) and displays a message confirming the occurred access to the operator on the touch screen of the computer. The process then returns to block 501 waiting for a next access to the bookbinding machine. At the end of an own work shift (not shown in the figure), the operator disconnects from the bookbinding machine by entering a corresponding disconnect command via the touch-screen of its computer; the processing agent transmits the disconnect command to the server, where the production manager updates the machine repository accordingly.

With reference now in particular to the swim-lane of the computer of the back-gluing machine, the process passes from block 508 to block 509 whenever a book block is supplied to the infeed station (as detected by a corresponding sensor). In response thereto, the processing agent reads (by means of the barcode reader) the barcode being printed on the front of the book block and decodes the corresponding book code. The processing agent at block 510 transmits the book code to the server. Moving to the swim-lane of the server, the production manager receives the book code at block 511 (being in a listening condition for it). In response thereto, the production manager at block 512 identifies the production batch corresponding to the book code and updates the corresponding tracking information in the production repository (book block under processing in the back-gluing machine by the operator extracted from the corresponding repository). The production manager at block 513 extracts the control information (job code, book title, barcode orientation and configuration information of the back-gluing machine) for the production batch from the production repository. The production manager at block 514 returns the control information to the computer of the back-gluing machine. The process then returns to block 511 waiting for a next book code. Referring again to the swim-lane of the computer of the back-gluing machine, the processing agent receives the control information at block 515 (being in a waiting condition for it from block 510) and updates the corresponding repository accordingly (if necessary). In response thereto, the processing agent at block 516 determines an (actual) orientation of the book block in the infeed station and compares it with its (expected) orientation retrieved from the control repository. For this purpose, the barcode reader determines an orientation of the barcode as read. Generally, each barcode is formed by a series of parallel lines having variable thicknesses and spacing, which represent information according to a corresponding coding; the coding is defined by rules that specify the representation of each symbol (for example, letters and numbers), in addition to a special initial symbol (start marker) and to a special ending symbol (stop marker). The barcode reader may then determine the orientation of the barcode being read according to the order in which its start/stop markers are read. The processing agent then determines the actual orientation of the book block based on the orientation of the barcode being read and on its orientation as printed on the book block (extracted from the control repository). For example, as visible in FIG. 2B, in the case at issue wherein the barcode extends in parallel to the spine of the book block on the opposite side thereof, if the barcode is read backward this means that the book block has been supplied to the infeed station longitudinally with the spine on the left, whereas if the barcode is read forward this means that the book block has been supplied to the infeed station with the spine on the right (looking forward). The flow of activity branches at block 517 according to an outcome of the comparison between the actual orientation and the expected orientation of the book block. If the actual orientation differs from the expected orientation, this means that the book block has been supplied to the infeed station in wrong way. In this case, the processing agent at block 518 enters an error condition wherein it blocks the back-gluing machine and displays a corresponding error message on the touch-screen of its computer. This allows the operator to re-position the book block correctly and then restart the back-gluing machine; in this way, the error is corrected without any waste of material and processing time. Conversely, if the actual orientation is equal to the expected orientation, if necessary the processing agent at block 519 configures the back-gluing machine according to the configuration information extracted from the control repository (for example, width of a transport channel according to the width of the book block). As soon as the book block passes the lining-application station (as detected by a corresponding sensor), if necessary the processing agent at block 520 positions the printing heads according to the sizes of the lining being applied to the book block and to the printing position of its identification information thereon. The processing agent at block 521 then synchronizes the printing of the identification information onto the lining (for example, barcode representing the job code on the front strip and alphanumeric text representing the book title on the central strip) while the book block passes under the printing heads. The process then returns from block 518 or from block 521 to block 508 waiting for a next book block. The back-gluing machine then completes the book block; not shown in the figure, as soon as the (completed) book block reaches the lay-down station (as detected by a corresponding sensor), the processing agent transmits a corresponding notification to the server, where the production manager updates the corresponding tracking information accordingly in the production repository (book block in transit from the back-gluing machine to the three-knife trimming machine). The book blocks being output by the back-gluing machine are transported manually to the three-knife trimming machine. This operation is facilitated by the fact that the book blocks may be identified by the operators through the alphanumeric text being visible on the central strips of the lining applied to their spines.

Referring now to the swim-lane of the computer of the three-knife trimming machine, the process passes from block 522 to block 523 whenever a book block is supplied to the infeed station (as detected by a corresponding sensor). In response thereto, the processing agent reads (by means of the barcode reader) the barcode being printed on the front strip of the lining of the book block and decodes the corresponding job code. The machining agent at block 524 transmits the job code to the server. Moving to the swim-lane of the server, the production manager receives the job code at block 525 (being in a listening condition for it). In response thereto, the production manager at block 526 updates the corresponding tracking information in the production repository (book block under processing in the three-knife trimming machine by the operator extracted from the corresponding repository). The production manager at block 527 extracts the control information (barcode orientation and configuration information of the three-knife trimming machine) for the production batch from the production repository. The production manager at block 528 returns the control information to the computer of the three-knife trimming machine. The process then returns to block 525 waiting for a next job code. Referring again to the swim-lane of the computer of the three-knife trimming machine, the processing agent receives the control information at block 529 (being in a waiting condition for it from block 524) and updates the corresponding repository accordingly (if necessary). In response thereto, the processing agent at 530 determines the actual orientation of the book block in the infeed station and compares it to its expected orientation. Similarly to above, for this purpose the processing agent determines the actual orientation of the book block based on the orientation of the barcode being read and the orientation of the barcode as printed on the fastening lining (extracted from the control repository). For example, as visible in FIG. 2E, in the case at issue wherein the barcode extends along the spine of the book block, if the barcode is read backward this means that the book block has been supplied to the infeed station longitudinally with the spine to the right, whereas if the barcode is read forward this means that the book block has been supplied to the infeed station with the spine to the left (looking forward). The flow of activity braches at block 531 according to an outcome of this comparison. If the actual orientation is different from the expected orientation (book block supplied to the infeed station in wrong way), the processing agent at block 532 enters an error condition wherein it blocks the three-knife trimming machine and displays a corresponding error message on the touch-screen of its computer (as above, to allow the operator to re-position the book block correctly and then restart the three-knife trimming machine, thereby correcting the error without any waste of material and processing time). Conversely, if the actual orientation is equal to the expected orientation, if necessary the processing agent at block 533 configures the three-knife trimming machine according to the configuration information extracted from the control repository (for example, cutting positions according to the format of the book block). The process then returns from block 532 or from block 533 to block 522 waiting for a next book block. The three-knife trimming machine then trims the book block; not shown in the figure, as soon as the (trimmed) book block reaches the lay-down station (as detected by a corresponding sensor), the processing agent transmits a corresponding notification to the server, where the production manager updates the corresponding tracking information accordingly in the production repository (book block in transit from the three-knife trimming machine to the case-in machine). The book blocks being output by the three-knife trimming machine are transported manually to the case-in machine. As above, this operation is facilitated by the fact that the book blocks may be identified by the operators through the alphanumeric text being visible on the central strips of the linings applied to their spines.

With reference now to the swim-lane of the computer of the case-in machine, the process passes from block 534 to block 535 whenever a book block is supplied to the book-block infeed station (as detected by a corresponding sensor). In response thereto, the processing agent reads (by means of the barcode reader) the barcode being printed on the front strip of the lining of the book block and decodes the corresponding job code. The processing agent at block 536 transmits the job code to the server. Moving to the swim-lane of the server, the production manager receives the job code at block 537 (being in a listening condition for it). In response thereto, the production manager at block 538 updates the corresponding tracking information in the production repository (book block under processing in the case-in machine by the operator extracted from the corresponding repository). The production manager at block 539 extracts the control information (barcode orientation, configuration information of the case-in machine and reference image of the cover) for the production batch from the production repository. The production manager at block 540 returns the control information to the computer of the case-in machine. The process then returns to block 537 waiting for a next job code. Referring again to the swim-lane of the computer of the case-in machine, the processing agent receives the control information at block 541 (being in a waiting condition for it from block 536) and updates the corresponding repository accordingly (if necessary). In response thereto, the processing agent at block 542 determines the actual orientation of the book block in the infeed station (based on the orientation of the barcode being read and on the orientation of the barcode as printed on the book block) and compares it with its expected orientation as above. The flow of activity branches at block 543 according to an outcome of this comparison. If the actual orientation is different from the expected orientation (book block supplied to the infeed station in wrong way), the processing agent at block 544 enters an error condition wherein it blocks the case-in machine and displays a corresponding message on the touch-screen of its computer (as above, to allow the operator to re-position the book block correctly and then restart the case-in machine, thereby correcting the error without any waste of material and processing time). Conversely, if the actual orientation is equal to the expected orientation, the flow of activity branches at block 545 according to the processing batch. If the book block belongs to a new processing batch (as determined by a job code difference from that of a previous book block, saved in a corresponding variable), the processing agent at block 546 pauses the book-block infeed station and (if necessary) configures the case-in machine according to the configuration information extracted from the control repository (for example, transport of the book block according to its format). The processing agent at block 547 displays the reference image (extracted from the control repository) on the touch-screen of the case-in machine. The operator uses the reference image to identify a stack of covers (transported manually to the case-in machine) to be applied to the book blocks of the new processing batch. Once this stack of covers has been loaded into the hopper of the cover infeed station (as indicated by a corresponding command entered by the operator onto the touch-screen of the case-in machine), the processing agent restarts the book-block infeed station. The process then continues to block 548 from block 547 or directly from block 545 if the processing batch has not changed. At this point, the processing agent acquires (by means of the camera) a (current) image of the cover being ready to be applied to the book block. The processing agent at block 549 compares the current image with the reference image (extracted from the control repository) by calculating an index of their similarity, such as the Sørensen-Dice coefficient. The flow of activity merges at block 550 according to an outcome of this comparison. If the similarity index is, possibly strictly, lower than a threshold value (for example, 0.7-0.9 for values from 0 to 1), this means that the current image does not match the reference image. In this case, the processing agent at block 551 enters an error condition (because the cover is not correct), wherein it blocks the case-in machine and displays a corresponding error message on the touch-screen of its computer; in this case as well, this allows the operator to remove the covers replacing them with the correct ones in the cover infeed station and then to restart the case-in machine, thereby correcting the error without any waste of material and processing time. The process then returns from block 544, from block 551 or directly from block 550 (if the similarity index is, possibly strictly, higher than the threshold value meaning that the current image matches the reference image and therefore the cover is correct) to block 534 waiting for a next book block. The case-in machine then completes the corresponding book; not shown in the figure, as soon as the book reaches the lay-down station (as detected by a corresponding sensor), the processing agent transmits a corresponding notification to the server, where the production manager updates the corresponding tracking information accordingly in the production repository (number of produced books being incremented).

Conversely (not shown in the figure), a stack of covers may already have been loaded into the hopper of the cover infeed station. In this case, the processing agent acquires (by means of the camera) a (current) image of the cover that is ready to be applied to a book block and transmits it to the server. In response thereto, the production manager identifies the production batch which reference image matches the current image in the production repository, extracts the control information as above for the production batch from the corresponding entry, and returns it to the computer of the case-in machine. In response thereto, if necessary the processing agent configures the case-in machine according to the configuration information as above. In this case, the processing agent instead displays the book title on the touch-screen of the case-in machine. The operator uses the book title to identify the book blocks to which the covers are to be applied. Whenever a book block is supplied to the book-block infeed station (as detected by the corresponding sensor), the processing agent reads (by means of the barcode reader) the barcode being printed on the front strip of the lining, decodes the corresponding job code and verifies the orientation of the book block as above. In this case, the processing agent instead compares the job code being read from the book block with the job code being received from the server. If the two job codes differ, the processing agent enters an error condition as above (because the book block is incorrect).

In this way it is possible to automatically coordinate the various processing steps of the book blocks, with no (or in any case reduced) intervention by the operators. In addition, this allows tracking the production of the books, so as to have a real-time representation of the progress of the jobs corresponding to the production batches. The tracking information may be used to schedule the submission of jobs (in order to optimize their execution) and/or to interface with other company management systems (for example, a purchasing system, a logistics system, a sale system, and the like).

### Modifications

Naturally, in order to satisfy local and specific requirements, a person skilled in the art may apply many logical and/or physical modifications and alterations to the present invention. More specifically, although this invention has been described with a certain degree of detail with reference to one or more embodiments thereof, it should be understood that various omissions, substitutions and changes in the form and details as well as other embodiments are possible. Particularly, different embodiments of the present disclosure may be practiced even without the specific details (such as the numerical values) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any embodiment of the present disclosure may be incorporated in any other embodiment as a matter of general design choice. Moreover, items presented in a same group and different embodiments, examples or alternatives are not to be construed as de facto equivalent to each other (but they are separate and autonomous entities). In any case, each numerical value should be read as modified according to applicable tolerances; particularly, unless otherwise indicated, the terms “substantially”, “about”, “approximately” and the like should be understood as within 10%, preferably 5% and still more preferably 1%. Moreover, each range of numerical values should be intended as expressly specifying any possible number along the continuum within the range (comprising its end points). Ordinal or other qualifiers are merely used as labels to distinguish elements with the same name but do not by themselves connote any priority, precedence or order. The terms include, comprise, have, contain, involve and the like should be intended with an open, non-exhaustive meaning (i.e., not limited to the recited items), the terms based on, dependent on, according to, function of and the like should be intended as a non-exclusive relationship (i.e., with possible further variables involved), the term a/an should be intended as one or more items (unless expressly indicated otherwise), and the term means for (or any means-plus-function formulation) should be intended as any structure adapted or configured for carrying out the relevant function.

For example, an embodiment provides a method for use in production of books in a bookbinding plant. However, the books may be of any type to which the application of fastening linings is contemplated (for example, with hard-cover, with soft-cover of lay-flat type and so on) and the method may relate to the whole or only part of their production in any bookbinding plant (see below).

In an embodiment, for each of the books to be produced the method comprises receiving a book block corresponding to the book. However, the book block may be of any type (for example, with signatures or sheets, with the sheets/signatures being bound in any way, such as sewn, glued and so on) and it may be received in any way (for example, loaded manually, transported automatically and so on).

In an embodiment, the book block has identification information of optical-readable type being visible outside the book block. However, the identification information may be of any type (for example, a barcode, a two-dimensional code, text, any combination thereof and so on) and with any content (for example, an identifier of the book, an identifier of a production batch, a book title, characteristics of the book, such as sizes, with/without headband, advertising paper book band, bookmark and the like, the corresponding control information or part thereof, and so on).

In an embodiment, for each of the books the method comprises reading the identification information from the book block by means of a reading device. However, the reading device may be of any type (for example, a barcode reader, a camera with a program for two-dimensional barcode reading, for character recognition or for image recognition, and so on).

In an embodiment, for each of the books the method comprises printing further identification information of optical-readable type. However, the further identification information may be of any type (for example, either the same or different with respect to the identification information) and printed in any way (for example, while the book block is moving or by stopping it for this purpose, under the control of a local control system with or without interaction with a remote processing system, and so on).

In an embodiment, the further identification information is corresponding to the identification information. However, the further identification information may correspond to the identification information in any way (for example, derived from it, such as extracted from a remote/local repository, equal to it or to a part thereof, and so on).

In an embodiment, the further identification information is printed onto a fastening lining corresponding to the book block. However, the fastening lining may be of any type (for example, of any length, width, material and so on); moreover, the further identification information may be printed onto the fastening lining at any position (for example, onto one or more strips thereof, with code and text divided onto several strips or grouped onto the same strip, and so on) and at any phase (for example, between the application of the lining to the spine and its application to the sides of the book block, before the application to the book block, after the complete application to the book block and so on).

In an embodiment, the further identification information is printed by means of a printing device. However, the printing device may be of any type (for example, of inkjet type, of contact type, with any number of printing heads, with fixed or movable printing heads, and so on).

In an embodiment, for each of the books the method comprises applying the fastening lining to the book block. However, the fastening lining may be applied in any way (for example, with the book block stationary or moving, with or without pressing, and so on).

In an embodiment, the further identification information is visible outside the book block with the fastening lining applied thereto for use in a next processing of the book block in the bookbinding plant. However, the further identification information may be used in any way (for example, manually and/or automatically) for any further processing of the book block (for example, configuring processing stations, controlling moving, tracking production and so on).

Further embodiments provide additional advantageous features, which may however be omitted at all in a basic implementation.

In an embodiment, the method comprises applying a pair of endpapers to the book block after said reading the identification information, the endpapers covering the identification information. However, the endpapers may be of any type (for example, of any sizes, graphical aspect, material and so on) and they may be applied at any time (for example, immediately after reading the identification information, after one or more other processing steps of the book blocks and so on).

In an embodiment, the method comprises printing the further identification information onto the fastening lining being laid flat. However, the possibility is not excluded of printing the further identification information with the fastening lining arranged in any other way (for example, while it is unrolled, when it is already folded to embrace the spine of the book block and so on).

In an embodiment, the further identification information is printed after an application of the fastening lining to a spine of the book block and before an application of the fastening lining to corresponding portions being adjacent to the spine of a front and of a back of the book block. However, this operation may be performed at any time (for example, immediately after the application of the fastening lining to the spine, immediately before the application of the fastening lining to the front/back, with any delay/advance with respect thereto, and so on).

In an embodiment, the method comprises printing the further identification information onto a central portion of the fastening lining for application to a spine of the book block, onto a front lateral portion of the fastening lining for application to a front of the book block and/or onto a back lateral portion of the fastening lining for application to a back of the book block. However, the further identification information may be printed onto any portion of the fastening lining (for example, onto any number of portions, fixed or selectable dynamically, at any position along each portion, before and/or after the application of the corresponding portion of the fastening lining to the book block, and so on).

In an embodiment, the method comprises retrieving the further identification information from a memory structure through an identification code comprised in the identification information. However, the memory structure may be of any type (for example, a database, a set of files, local/remote and so on) and the further identification information may be retrieved from it through the identification code in any way (for example, as access key, file name and so on).

In an embodiment, the method comprises determining an orientation of the book block according to an orientation of the identification information as read and as arranged on the book block. However, the orientation of the book block and of the identification information may be of any type (for example, longitudinal, transversal and so on) and the orientation of the book block may be determined in any way (for example, any number of times, such as in corresponding bookbinding machines, according to the orientation of a code, a text and so on).

In an embodiment, the method comprises controlling a loading of the book block in the bookbinding plant according to the orientation of the book block. However, the loading of the book block may be controlled in any way (for example, by comparing the actual orientation with an expected orientation corresponding to the book block or pre-defined for each bookbinding machine, stopping the corresponding bookbinding machine to correct the error, turning the book block automatically and so on).

In any case, the features of the orientation of the book block may also be used without the feature of the printing of the further identification information (for example, when the identification information remains visible, such as in the case of no application of endpapers, only before covering the identification information and so on).

In an embodiment, the method comprises printing the further identification information comprising a human-readable text. However, the text may be of any type (for example, containing alphanumeric characters, symbols, graphics and so on) and with any content (for example, title, author, publisher, client and so on).

In an embodiment, the method comprises reading the further identification information from the book block by means of one or more further reading devices. However, the further reading devices may be in any number, at any position (for example, at the entrance of corresponding bookbinding machines, along conveyors of the book blocks and so on) and of any type (for example, either the same or different with respect to the reading device of the identification information).

In an embodiment, the method comprises controlling corresponding one or more processing steps of the book block in the bookbinding plant according to the identification information being read by the reading device and/or to the further identification information being read by each of the further reading devices. However, the processing steps may be in any number and of any type (for example, transport, such as inside bookbinding machines, between bookbinding machines and the like, transformation, such as application of endpapers/linings, three-knife trimming, application of covers and the like, packaging, shipping and so on).

In an embodiment, the method comprises printing the further identification information comprising a further identification code. However, the further identification code may be of any type (for example, either the same or different with respect to the identification code).

In an embodiment, the method comprises retrieving configuration information of one or more bookbinding machines of the bookbinding plant adapted to implementing corresponding groups of the processing steps of the book block. However, the bookbinding machines may be in any number and of any type (for example, conveyors, three-knife trimming machine, case-in machine, perfect-binding machine and so on), each adapted to implementing any number of processing steps of the book block (for example, in one or more processing stations thereof).

In an embodiment, the configuration information is retrieved from a memory structure through the corresponding identification information being read by the reading device and/or to the further identification information being read by each of the further reading devices. However, the memory structure may be of any type and the configuration information may be retrieved therefrom in any way (for example, either the same or different with respect to the retrieving of the further identification information).

In an embodiment, the method comprises configuring each of the bookbinding machines according to the configuration information for the corresponding group of processing steps of the book block. However, the bookbinding machines may be configured in any way (for example, according to format, thickness, type, destination and so on of the book block).

In an embodiment, the method comprises determining one or more further orientations of the book block each according to an orientation of the further identification information as read by a corresponding one of the further reading devices and as arranged on the fastening lining. However, the further orientation of the book block and of the further identification information may be of any type (for example, either the same or different with respect to above) and the further orientation of the book block may be determined in any way (for example, any number of times, such as in corresponding bookbinding machines, according to the orientations of the identification code, of the alphanumeric text and so on).

In an embodiment, the method comprises controlling corresponding further loadings of the book block in the bookbinding plant according to the further orientations of the book block. However, the further loadings may be controlled in any way (for example, either the same or different with respect to above).

In any case, the features of the further orientations of the book block may also be used without the feature of the printing of the further identification information onto the fastening lining (for example, by printing the further identification information onto an exposed page of one or both endpapers, and so on).

In an embodiment, the method comprises retrieving matching information from a memory structure associating the further identification information and a reference image of a cover to be applied to the book block. However, the cover may be of any type (for example, hard, soft and so on) and the memory structure may be of any type (for example, either the same or different with respect to the memory structures of above); the matching information may be of any type (for example, the reference image corresponding to the further identification code, the further identification code and/or the book title corresponding to the reference image, and so on) and retrieved in any way (for example, locally, remotely and so on).

In an embodiment, the method comprises controlling an application of the cover to the book with the fastening lining applied thereto according to the matching information. However, the matching information may be used in any way to control the application of the cover (for example, verifying the matching of the cover, suggesting the cover and/or the book block to be loaded into the case-in machine, and so on).

In an embodiment, the method comprises retrieving the matching information comprising the reference image corresponding to the further identification information. However, the reference image may be retrieved in any way (see above).

In an embodiment, the method comprises acquiring a current image of the cover being ready to be applied to the book block by means of a camera. However, the camera may be of any type (for example, of color type, of black/white type and so on).

In an embodiment, the method comprises verifying a correctness of the cover according to a comparison of the current image with the reference image. However, the two images may be compared in any way (for example, by calculating any similarity index at the level of any group of pixels, using a neural network being suitably trained and so on).

In an embodiment, the method comprises displaying the reference image onto a monitor to assist an operator in loading the cover. However, the reference image may be displayed onto any monitor (for example, of the case-in machine, of a smart-phone of the operator and so on).

In an embodiment, the method comprises identifying the reference image corresponding to the current image. However, the reference image may be identified in any way (for example, through an image search algorithm, a neural network being suitably trained and so on).

In an embodiment, the method comprises retrieving the matching information comprising a descriptor of the book block corresponding to the reference image. However, the descriptor may be of any type (for example, title, author, further identification code and so on) and retrieved in any way (see above).

In an embodiment, the method comprises displaying the descriptor of the book block onto a monitor to assist an operator in loading the book block. However, the descriptor may be displayed onto any monitor (for example, either the same or different with respect to above).

In any case, the above-mentioned features relating to the images of the cover may also be used without the feature of the printing of the further identification information onto the fastening lining (for example, by printing the further identification information onto an exposed page of one or both endpapers, using the identification information when it remains visible, such as in the case of no application of endpapers, and so on).

In an embodiment, the method comprises saving tracking information relating to the production of the books according to the identification information being read by the reading device and/or to the further identification information being read by each of the further reading devices. However, the tracking information may be of any type (for example, current processing step, current number of copies of the corresponding production batch, current operator, possible error and so on) and saved in any way (for example, into a dedicated memory structure, local or remote, into one of the memory structures of above and so on).

In an embodiment, the method is for use in the production of books with hard-covers. However, the hard-covers may be of any type (for example, with any thickness, material, finish and so on).

Generally, similar considerations apply if the same solution is implemented with an equivalent method (by using similar steps with the same functions of more steps or portions thereof, removing some non-essential steps or adding further optional steps); moreover, the steps may be performed in a different order, concurrently or in an interleaved way (at least in part).

An embodiment provides a system for use in production of books in a bookbinding plant. In an embodiment, the system comprises an infeed station for receiving each of book blocks corresponding to the books to be produced. In an embodiment, the book block has identification information of optical-readable type being visible outside the book block. In an embodiment, the system comprises a reading device for reading the identification information from each book block. In an embodiment, the system comprises a lining-application station for applying a fastening lining to each book block. In an embodiment, the system comprises a printing device for printing further identification information of optical-readable type corresponding to the identification information onto the fastening lining corresponding to each book block. In an embodiment, the further identification information is visible outside the book block with the fastening lining applied thereto for use in a next processing of the book block in the bookbinding plant. However, this result may be achieved with components of any type (with the same considerations of above relating to the steps of the method which apply by analogy to the corresponding components).

In an embodiment, the system comprises one or more further reading devices for reading the further identification information from each book block. However, the further reading devices may be in any number, at any position and of any type (see above).

In an embodiment, the system comprises one or more control systems for controlling corresponding one or more processing steps of the book block in the bookbinding plant according to the identification information being read by the reading device and/or to the further identification information being read by each of the further reading devices. However, the control systems may be in any number, at any position and of any type (for example, a computer, a controller and the like for each bookbinding machine or group of them up to all, stand-alone or connected among them, with or without a central processing system, and so on) to control processing steps in any number and of any type (see above).

In an embodiment, the system comprises a computing system for saving tracking information relating to the production of the books according to the identification information being read by the reading device and/or to the further identification information being read by each of the further reading devices. However, the computing system may be of any type (for example, implemented by a local/remote physical or virtual server, by the same computers of each bookbinding machine, either networked or stand-alone, and so on) to save tracking information of any type and in any way (see above).

An embodiment provides a back-gluing machine comprising the system of above. However, the back-gluing machine may be of any type (for example, partial, different and/or additional processing stations with respect to the ones mentioned above, such as a manual infeed station, a milling station and so on).

An embodiment provides a bookbinding plant comprising the system of above. However, the bookbinding plant may be of any type (for example, comprising any number, down to one, of partial, different and/or additional bookbinding machines with respect to the ones mentioned above, such as traditional sewing machines, packaging machines of the books and the like, with the bookbinding machines separated from each other or connected at least in part via corresponding conveyors, and so on).

Generally, similar considerations apply if the system, the back-gluing machine and the bookbinding plant each has a different structure, comprises equivalent components (for example, of different materials) or has other operative characteristics. In any case, every component thereof may be separated into more elements, or two or more components may be combined together into a single element; moreover, each component may be replicated to support the execution of the corresponding operations in parallel. Moreover, unless specified otherwise, any interaction between different components generally does not need to be continuous, and it may be either direct or indirect through one or more intermediaries.

An embodiment provides a program for causing a computing machine to perform the method of above when the computer program is executed on the computing machine. In an embodiment, for each of the books to be produced the method comprises reading identification information of optical-readable type being visible outside a book block corresponding to the book to be produced by means of a reading device. In an embodiment, for each of the books to be produced the method comprises printing further identification information of optical-readable type corresponding to the identification information onto a fastening lining corresponding to the book block by means of a printing device. In an embodiment, the further identification information is visible outside the book block with the fastening lining applied thereto for use in a next processing of the book block in the bookbinding plant. An embodiment provides a computer program product, the computer program product comprising one or more computer readable storage media having program instructions collectively stored in the readable storage media, the program instructions being readable by a computing machine to cause the computing machine to perform the same method. However, the (computer) program may be implemented as a stand-alone module, as a plug-in for a pre-existing program (for example, a control program of the back-gluing machine) or even directly in the latter. Moreover, the program may be executed on any computing machine (for example, an industrial PC, a micro-controller and so on).

In further embodiments the program may implement additional steps (which may however be completely omitted in a basic implementation) similarly to above.

Generally, similar considerations apply if the program is structured in a different way, or if additional modules or functions are provided; likewise, the memory structures may be of other types, or they may be replaced with equivalent entities (not necessarily consisting of physical storage media). The program may take any form suitable to be used by the computing machine, thereby configuring the computing machine to perform the desired operations; particularly, the program may be in the form of external or resident software, firmware or microcode (either in object code or in source code, for example, to be compiled or interpreted). Moreover, it is possible to provide the program on any computer readable storage medium; the storage medium is any tangible medium (different from transitory signals per se) that may retain and store instructions for use by the computing machine. For example, the storage medium may be of electronic, magnetic, optical, electromagnetic, infrared or semiconductor type; examples of such storage medium are fixed disks (where the program may be pre-loaded), removable disks, memory keys (for example, of USB type) and the like. The program may be downloaded to the computing machine from the storage medium or via a network (for example, the Internet, a wide area network and/or a local area network comprising transmission cables, optical fibers, wireless connections, network devices); one or more network adapters in the computing machine receive the program from the network and forward it for storage into one or more storage devices of the computing machine. In any case, the solution according to an embodiment of the present invention lends itself to be implemented even with a hardware structure (for example, by electronic circuits integrated on one or more chips of semiconductor material), or with a combination of software and hardware suitably programmed or otherwise configured.

1. A method for use in production of books in a bookbinding plant, wherein for each of the books to be produced the method comprises:
receiving a book block corresponding to the book, the book block having identification information of optical-readable type being visible outside the book block,
reading the identification information from the book block by means of a reading device,
printing further identification information of optical-readable type corresponding to the identification information onto a fastening lining corresponding to the book block by means of a printing device, and
applying the fastening lining to the book block, the further identification information being visible outside the book block with the fastening lining applied thereto for use in a next processing of the book block in the bookbinding plant.

2. The method according to claim 1, wherein the method comprises:
applying a pair of endpapers to the book block after said reading the identification information, the endpapers covering the identification information.

3. The method according to claim 1, wherein the method comprises:
printing the further identification information onto the fastening lining being laid flat, after an application of the fastening lining to a spine of the book block and before an application of the fastening lining to corresponding portions being adjacent to the spine of a front and of a back of the book block.

4. The method according to claim 1, wherein the method comprises:
printing the further identification information onto a central portion of the fastening lining for application to a spine of the book block, onto a front lateral portion of the fastening lining for application to a front of the book block and/or onto a back lateral portion of the fastening lining for application to a back of the book block.

5. The method according to claim 1, wherein the method comprises:
retrieving the further identification information from a memory structure through an identification code comprised in the identification information.

6. The method according to claim 1, wherein the method comprises:
determining an orientation of the book block according to an orientation of the identification information as read and as arranged on the book block, and
controlling a loading of the book block in the bookbinding plant according to the orientation of the book block.

7. The method according to claim 1, wherein the method comprises:
printing the further identification information comprising a human-readable text.

8. The method according to claim 1, wherein the method comprises:
reading the further identification information from the book block by means of one or more further reading devices, and
controlling corresponding one or more processing steps of the book block in the bookbinding plant according to the identification information being read by the reading device and/or to the further identification information being read by each of the further reading devices.

9. The method according to claim 8, wherein the method comprises:
printing the further identification information comprising a further identification code.

10. The method according to claim 8, wherein the method comprises:
retrieving configuration information of one or more bookbinding machines of the bookbinding plant adapted to implementing corresponding groups of the processing steps of the book block, the configuration information being retrieved from a memory structure through the corresponding identification information being read by the reading device and/or the further identification information being read by each of the further reading devices, and
configuring each of the bookbinding machines according to the configuration information for the corresponding group of processing steps of the book block.

11. The method according to claim 1, wherein the method comprises:
determining one or more further orientations of the book block each according to an orientation of the further identification information as read by a corresponding one of the further reading devices and as arranged on the fastening lining, and
controlling corresponding further loadings of the book block in the bookbinding plant according to the further orientations of the book block.

12. The method according to claim 8, wherein the method comprises:
retrieving matching information from a memory structure associating the further identification information and a reference image of a cover to be applied to the book block, and
controlling an application of the cover to the book block with the fastening lining applied thereto according to the matching information.

13. The method according to claim 12, wherein the method comprises:
retrieving the matching information comprising the reference image corresponding to the further identification information, and
acquiring a current image of the cover being ready to be applied to the book block by means of a camera,
verifying a correctness of the cover according to a comparison of the current image with the reference image.

14. The method according to claim 12, wherein the method comprises:
retrieving the matching information comprising the reference image corresponding to the further identification information, and
displaying the reference image onto a monitor to assist an operator in loading the cover.

15. The method according to claim 12, wherein the method comprises:
acquiring a current image of the cover ready to be applied to the book block by a camera
identifying the reference image corresponding to the current image,
retrieving the matching information comprising a descriptor of the book block corresponding to the reference image, and
displaying the descriptor of the book block onto a monitor to assist an operator in loading the book block.

16. The method according to any claim 8, wherein the method comprises:
saving tracking information relating to the production of the books according to the identification information being read by the reading device and/or to the further identification information being read by each of the further reading devices.

17. (canceled)

18. A system for use in production of books in a bookbinding plant wherein the system comprises:
an infeed station for receiving each of book blocks corresponding to the books to be produced, the book block having identification information of optical-readable type being visible outside the book block,
a reading device for reading the identification information from each book block,
a lining-application station for applying a fastening lining to each book block,
a printing device for printing further identification information of optical-readable type corresponding to the identification information onto the fastening lining corresponding to each book block, the further identification information being visible outside the book block with the fastening lining applied thereto for use in a next processing of the book block in the bookbinding plant.

19. The system according to claim 18, wherein the system comprises:
one or more further reading devices for reading the further identification information from each book block, and
one or more control systems for controlling corresponding one or more processing steps of the book block in the bookbinding plant according to the identification information being read by the reading device and/or to the further identification information being read by each of the further reading devices.

20. The system according to claim 19, wherein the system comprises:
a computing system for saving tracking information relating to the production of the books according to the identification information being read by the reading device and/or to the further identification information being read by each of the further reading devices.

21.-23. (canceled)

24. A computer program product, the computer program product comprising one or more computer readable storage media having program instructions collectively stored in the readable storage media, the program instructions being readable by a computing machine to cause the computing machine to perform a method for producing books when the computer program is executed on the computing machine, wherein for each of the books to be produced the method comprises:
reading identification information of optical-readable type being visible outside a book block corresponding to the book to be produced by a reading device, and
printing further identification information of optical-readable type corresponding to the identification information on a fastening lining corresponding to the book block by a printing device, the further identification information being visible outside the book block with the fastening lining applied thereto for use in a next processing of the book block in the bookbinding plant.
